(19) United States
(12) Patent Application Publication
(10) Pub. No.: US 2016/0117199 A1
(43) Pub. Date: Apr. 28, 2016

(54) COMPUTING SYSTEM WITH THERMAL MECHANISM AND METHOD OF OPERATION THEREOF

(71) Applicant: Samsung Electronics Co., Ltd., Suwon-si (KR)

(72) Inventor: Sridhar Sundaram, Austin, TX (US)

(21) Appl. No.: 14/804,119

(22) Filed: Jul. 20, 2015

Related U.S. Application Data
(60) Provisional application No. 62/069,608, filed on Oct. 28, 2014.

(51) Int. Cl. G06F 9/50; G06F 1/32

(52) U.S. Cl. CPC G06F 9/5094; G06F 1/329

(57) ABSTRACT

A computing system includes: a monitoring block configured to calculate a present power for each of multiple resource units; a thermal block, coupled to the monitoring block, configured to dynamically calculate a thermal candidate set based on the present power, the thermal candidate set for representing a present thermal load for the multiple resource units; and a target block, coupled to the thermal block, configured to determine a target resource based on the thermal candidate set for performing a target task using the target resource.

### CROSS-REFERENCE TO RELATED APPLICATION(S)

This application claims the benefit of U.S. Provisional Patent Application Ser. No. 62/069,608 filed Oct. 28, 2014, and the subject matter thereof is incorporated herein by reference thereto.

### TECHNICAL FIELD

An embodiment of the present invention relates generally to a computing system, and more particularly to a system for thermal mechanism.

### BACKGROUND

Modern consumer and industrial electronics, such as computing systems, servers, appliances, televisions, cellular phones, automobiles, satellites, and combination devices, are providing increasing levels of functionality to support modern life. While the performance requirements can differ between consumer products and enterprise or commercial products, there is a common need for more performance while reducing power consumption. Research and development in the existing technologies can take a myriad of different directions.

One such direction includes improvements in managing available resources. As electronic devices become smaller, lighter, and require less power, uneven distribution of resource utilization can hinder performance of the devices. Efficiently or effectively managing the available resources can provide the increased levels of performance and functionality.

Thus, a need still remains for a computing system with thermal mechanism for improved processing performance while reducing power consumption through increased efficiency. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a system, including: a monitoring block configured to calculate a present power for each of multiple resource units; a thermal block, coupled to the monitoring block, configured to dynamically calculate a thermal candidate set based on the present power, the thermal candidate set for representing a present thermal load for the multiple resource units; and a target block, coupled to the thermal block, configured to determine a target resource based on the thermal candidate set for performing a target task using the target resource.

An embodiment of the present invention provides a method including: calculating a present power for each of multiple resource units; dynamically calculating with a control unit a thermal candidate set based on the present power, the thermal candidate set for representing a present thermal load for the multiple resource units; and determining a target resource based on the thermal candidate set for performing a target task using the target resource.

An embodiment of the present invention provides a system, including: a resource identification block configured to identify multiple resource units within a resource portion; an individual modeling block, coupled to the resource identification block, configured to generate unit-thermal profile for representing each of the multiple resource units; a relational modeling block, coupled to the individual modeling block, configured to generate a resource set profile including the unit-thermal profile for representing a relationship between the multiple resource units; and a characterization block, coupled to the relational modeling block, configured to calculate a thermal resistance-capacitance network based on the resource set profile for representing thermal interactions between the multiple resource units.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an exemplary block diagram of a computing system with thermal mechanism in an embodiment of the present invention.

FIG. 2 is an exemplary top view of a resource portion.

FIG. 3 is an exemplary diagram of a thermal model for the computing system 100.

FIG. 4 is an exemplary display of the computing system 100.

FIG. 5 is a control flow of the computing system.

FIG. 6 is an example diagram of the thermal mechanism in operation.

FIG. 7 is a flow chart of a method of operation of a computing system in an embodiment of the present invention.

### DETAILED DESCRIPTION

The following embodiments include dynamic calculation of thermal candidate set for representing nodes capable of performing or implementing a target task. The thermal candidate set can be used to determine a target resource for performing or implementing a target task.

The target resource can include a node thermally optimal, such as having the most thermal headroom or best balancing power consumption and performance, for performing or implementing the target task. The thermal candidate set can be dynamically calculated based on thermal resistance-capacitance network between nodes, present power, present thermal load, thermal model, or a combination thereof.

The following embodiments are described in sufficient detail to enable those skilled in the art to make and use the invention. It is to be understood that other embodiments would be evident based on the present disclosure, and that system, process, architectural, or mechanical changes can be made without departing from the scope of an embodiment of the present invention.

In the following description, numerous specific details are given to provide a thorough understanding of the invention. However, it will be apparent that the invention and various embodiments may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, an embodiment can be operated in any orientation.

The term “block” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof. Further, if a block is written in the apparatus claims section below, the blocks are deemed to include hardware circuitry for the purposes and the scope of apparatus claims.

The blocks in the following description of the embodiments can be coupled to one other as described or as shown. The coupling can be direct or indirect without or with, respectively, intervening between coupled items. The coupling can be physical contact or by communication between items.

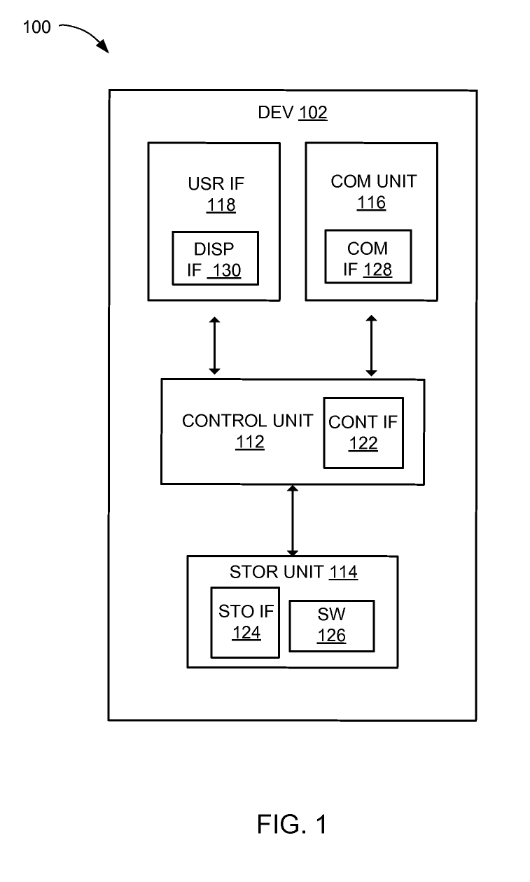

Referring now to FIG. 1, therein is shown an exemplary block diagram of a computing system 100 with thermal mechanism in an embodiment of the present invention. The computing system 100 can include a device 102. The device 102 can include a client device, a server, a display interface, or combination thereof.

For example, the device 102 can include a smart phone, a wearable device or a health monitor, a sensor or a processing device for Internet of Things (IoT), or a combination thereof. Also for example, the device 102 can include a computer, grid computing resources, a virtualized computer resource, cloud computing resource, routers, switches, peer-to-peer distributed computing devices, or a combination thereof. Also for example, the device 102 can include a server utilized by a service provider.

The device 102 can include a control unit 112, a storage unit 114, a communication unit 116, and a user interface 118. The control unit 112 can include a control interface 122. The control unit 112 can execute software 126 of the computing system 100.

In an embodiment, the control unit 112 provides the processing capability and functionality to the computing system 100. The control unit 112 can be implemented in a number of different manners. For example, the control unit 112 can be a processor or a portion therein, an application specific integrated circuit (ASIC) an embedded processor, a microprocessor, a central processing unit (CPU), a graphics processing unit (GPU), a hardware control logic, a hardware finite state machine (FSM), a digital signal processor (DSP), a hardware circuit with computing capability, or a combination thereof.

As a further example, various embodiments can be implemented on a single integrated circuit, with components on a daughter card or system board within a system casing, or distributed from system to system across various network topologies, or a combination thereof. Examples of network topologies include personal area network (PAN), local area network (LAN), storage area network (SAN), metropolitan area network (MAN), wide area network (WAN), or a combination thereof.

The control interface 122 can be used for communication between the control unit 112 and other functional units in the device 102. The control interface 122 can also be used for communication that is external to the device 102.

The control interface 122 can receive information from the other functional units or from external sources, or can transmit information to the other functional units or to external destinations. The external sources and the external destinations refer to sources and destinations external to the device 102.

The control interface 122 can be implemented in different ways and can include different implementations depending on which functional units or external units are being interfaced with the control interface 122. For example, the control interface 122 can be implemented with a pressure sensor, an inertial sensor, a microelectromechanical system (MEMS), optical circuitry, waveguides, wireless circuitry, wireline circuitry, or a combination thereof.

The storage unit 114 can store the software 126. The storage unit 114 can also store relevant information, such as data, images, programs, sound files, or a combination thereof. The storage unit 114 can be sized to provide additional storage capacity.

The storage unit 114 can be a volatile memory, a nonvolatile memory, an internal memory, an external memory, or a combination thereof. For example, the storage unit 114 can be a nonvolatile storage such as non-volatile random access memory (NVRAM), Flash memory, disk storage, or a volatile storage such as static random access memory (SRAM), dynamic random access memory (DRAM), any memory technology, or combination thereof.

The storage unit 114 can include a storage interface 124. The storage interface 124 can be used for communication with other functional units in the device 102. The storage interface 124 can also be used for communication that is external to the device 102.

The storage interface 124 can receive information from the other functional units or from external sources, or can transmit information to the other functional units or to external destinations. The external sources and the external destinations refer to sources and destinations external to the device 102.

The storage interface 124 can include different implementations depending on which functional units or external units are being interfaced with the storage unit 114. The storage interface 124 can be implemented with technologies and techniques similar to the implementation of the control interface 122.

For illustrative purposes, the storage unit 114 is shown as a single element, although it is understood that the storage unit 114 can be a distribution of storage elements. Also for illustrative purposes, the computing system 100 is shown with the storage unit 114 as a single hierarchy storage system, although it is understood that the computing system 100 can have the storage unit 114 in a different configuration. For example, the storage unit 114 can be formed with different storage technologies forming a memory hierarchal system including different levels of caching, main memory, rotating media, or off-line storage.

The communication unit 116 can enable external communication to and from the device 102. For example, the communication unit 116 can permit the device 102 to communicate with a second device (not shown), an attachment, such as a peripheral device, a communication path (not shown), or combination thereof.

The communication unit 116 can also function as a communication hub allowing the device 102 to function as part of the communication path and not limited to be an end point or terminal unit to the communication path. The communication unit 116 can include active and passive components, such as microelectronics or an antenna, for interaction with the communication path.

The communication unit 116 can include a communication interface 128. The communication interface 128 can be used for communication between the communication unit 116 and other functional units in the device 102. The communication interface 128 can receive information from the other functional units or can transmit information to the other functional units.

The communication interface 128 can include different implementations depending on which functional units are being interfaced with the communication unit 116. The communication interface 128 can be implemented with technologies and techniques similar to the implementation of the control interface 122, the storage interface 124, or combination thereof.

The user interface 118 allows a user (not shown) to interface and interact with the device 102. The user interface 118 can include an input device, an output device, or combination thereof. Examples of the input device of the user interface 118 can include a keypad, a touchpad, soft-keys, a keyboard, a microphone, an infrared sensor for receiving remote signals, other input devices, or any combination thereof to provide data and communication inputs.

The user interface 118 can include a display interface 130. The display interface 130 can include a display, a projector, a video screen, a speaker, or any combination thereof.

The control unit 112 can operate the user interface 118 to display information generated by the computing system 100. The control unit 112 can also execute the software 126 for the other functions of the computing system 100. The control unit 112 can further execute the software 126 for interaction with the communication path via the communication unit 116.

The device 102 can also be optimized for implementing an embodiment of the computing system 100 in a multiple device embodiment. The device 102 can provide additional or higher performance processing power.

For illustrative purposes, the device 102 is shown partitioned with the user interface 118, the storage unit 114, the control unit 112, and the communication unit 116, although it is understood that the device 102 can have any different partitioning. For example, the software 126 can be partitioned differently such that at least some function can be in the control unit 112 and the communication unit 116. Also, the device 102 can include other functional units not shown in for clarity.

The functional units in the device 102 can work individually and independently of the other functional units. For illustrative purposes, the computing system 100 is described by operation of the device 102 although it is understood that the device 102 can operate any of the processes and functions of the computing system 100.

Processes in this application can be hardware implementations, hardware circuitry, or hardware accelerators in the control unit 112. The processes can also be implemented within the device 102 but outside the control unit 112.

Processes in this application can be part of the software 126. These processes can also be stored in the storage unit 114. The control unit 112 can execute these processes for operating the computing system 100.

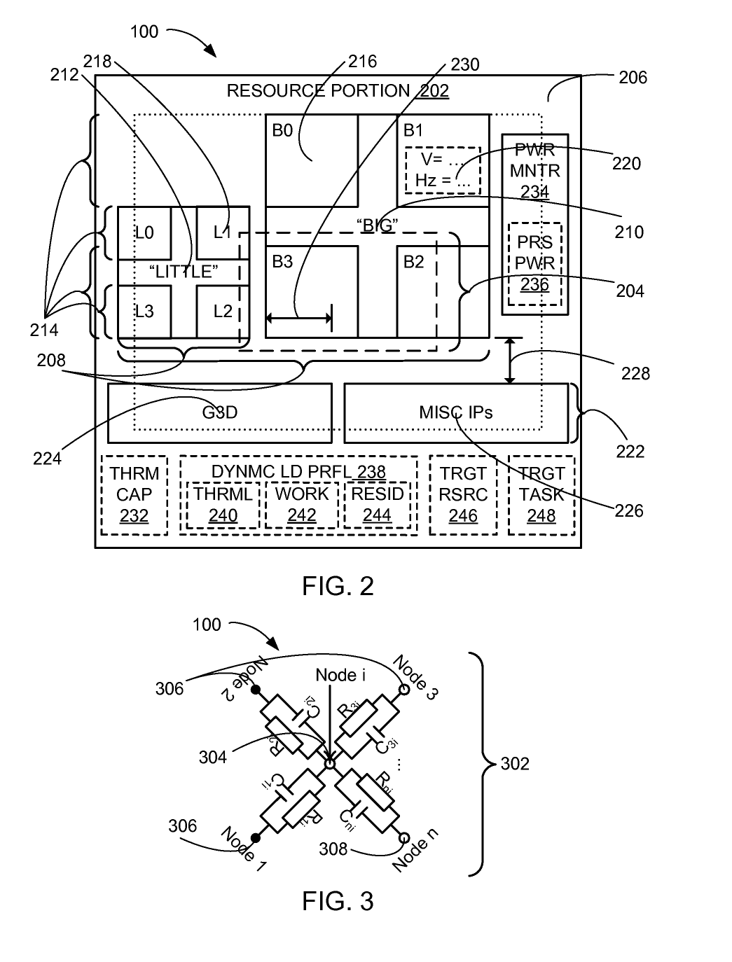

Referring now to FIG. 2, therein is shown an exemplary top view of a resource portion 202. The computing system 100 can include the resource portion 202. For example, the device 102 of FIG. 1 can include one or more instances of the resource portion 202.

For illustrative purposes, one instance of the resource portion 202 is shown as included in the control unit 112. However, it is understood that the control unit 112, the storage unit 114 of FIG. 1, the communication unit 116 of FIG. 1, the user interface 122 of FIG. 1, or a combination thereof can include one or more instances of the resource portion 202.

The resource portion 202 can be a single grouping of processing unit. The resource portion 202 can be a single physical unit of component or device for processing information. The resource portion 202 can be hardware. The resource portion 202 can include a device, an electronic component, active circuitry, passive circuitry, or a combination thereof. For example, the resource portion 202 can include a chip, a board, or a box. As a more specific example, the resource portion 202 can include a System on Chip (SoC), a mobile application processor (AP), or a combination thereof.

The resource portion 202 can include a central area 204, an outer area 206, or a combination thereof. The central area 204 can include a region located at or about a geometrical or physical center of the resource portion 202. The central area 204 can be with respect to a reference plane parallel to a board or a substrate for housing or affixing the resource portion 202. The exemplary top view can be a representation along the reference plane.

The outer area 206 can include a region located along the periphery of the resource portion 202 along the reference plane. The outer area 206 can surround the central area 204. The outer area 206 can be adjacent or abutting the central area 204. The outer area 206 and the central area 204 can be divided along an abstract boundary or a region between the outer area 206 and the central area 204.

The resource portion 202 can have different thermal or operational characteristics for the central area 204 and the outer area 206. The difference and utilization of the difference are described below.

The resource portion 202 can include one or more instances of the resource cluster 208. The resource cluster 208 can include a section or a segment within the resource cluster 208 for carrying out or executing instructions for the resource portion 202. The resource cluster 208 can include a processing cluster or a CPU cluster. The resource cluster 208 can include an active circuitry, a passive circuitry, a transistor, a gate, or a combination thereof for performing the basic arithmetic, logical, control, input-output (I/O), or a combination of operations thereof specified by the instructions.

For example, the resource portion 202 can include a first cluster 210 and a second cluster 212 for the resource cluster 208. The first cluster 210 and the second cluster 212 can each be independent instance of the resource cluster 208.

The first cluster 210 and the second cluster 212 can be based on various design characteristics for optimizing the resource portion 202. For example, the first cluster 210 and the second cluster 212 can include characteristics, such as size, capacity, speed, type, or a combination thereof same as or different from each other. As a more specific example, the first cluster 210 can be a “big” processing or CPU cluster with larger size, higher capacity, higher maximum speed, or a combination thereof in comparison to the second cluster 212, a “little” processing or CPU cluster.

The resource cluster 208, such as the first cluster 210 or the second cluster 212, can include one or more instances of a resource unit 214. The resource unit 214 is an independent processing unit within the resource cluster 208. The resource unit 214 can include a core for the processing or CPU cluster. For example, the first cluster 210, the second cluster 212, or a combination thereof can include a first resource 216 and a second resource 218, each representing an independent and separate processing or CPU core.

As a more specific example, the first cluster 210 can include four cores labeled ‘B0’, ‘B1’, ‘B2’, and ‘B3’ as exemplified in FIG. 2. Also as a more specific example, the second cluster 212 can include four cores labeled ‘L0’, ‘L1’, ‘L2’, and ‘L3’ as exemplified in FIG. 2. The first resource 216 and the second resource 218 can each be a unique and separate core for the mobile AP or the SoC.

The first resource 216 and the second resource 218 can be functionally separate or independent of each other. The first resource 216 and the second resource 218 can further be physically or geometrically separate or independent of each other.

The resource unit 214 can include an operational setting 220. The operational setting 220 is one designation or a grouping of designation controlling function for the resource unit 214. The operational setting 220 can affect a power consumption, a thermal condition, or a combination thereof for the resource portion 202, the resource cluster 208 therein, the resource unit 214 therein, or a combination thereof.

For example, the operational setting 220 can include a speed or a rate, a frequency, a voltage level, a state, or a combination thereof. As a more specific example, the operational setting 220 can include a sleep or an awaken state, a dynamic voltage and frequency scaling (DVFS) state, a specific voltage or frequency setting, or a combination thereof.

The resource portion 202 can include other functional section. The other functional sections can include a surrounding section 222. The surrounding section 222 is a section of circuitry or a device within the resource portion 202 independent and separate from the resource cluster 208 and having a location relevant to the resource cluster 208.

For example, the surrounding section 222 can include the functional section directly adjacent to or abutting the resource cluster 208. The surrounding section 222 can be directly adjacent to or abutting the resource cluster 208 without any intervening or functioning device or portion between the surrounding section 222 and the resource cluster 208. Also for example, the surrounding section 222 and the resource cluster 208 can be functionally separate or independent of each other, physically or geometrically separate or independent of each other, or a combination thereof.

As a more specific example, the surrounding section 222 can include a graphics section 224, a general section 226, or a combination thereof. The graphics section 224 can include circuitry within the resource portion 202 configured to process images. The graphics section 224 can correspond to the images for the display interface 130 of FIG. 1. The graphics section 224 can be represented as “G3D”. The general section 226 can include circuitry within the resource portion 202 configured to process miscellaneous instruction pointers (IPs).

The resource cluster 208, the surrounding section 222, or a combination thereof can be a unit of circuitry or device represented at a granularity level finer than the resource portion 202. The resource unit 214 can be a unit of circuitry or device represented at a granularity level finer than the resource cluster 208.

The resource portion 202 can include physical characteristics or specifications for lower granularity nodes. The node represents a single entity or unit capable of consuming power, generating heat, processing information, or a combination thereof, such as a component, a device, or a combination or a grouping thereof. The node can represent the resource cluster 208, the surrounding section 222, the resource unit 214, or a combination thereof.

The physical characteristics or specifications for the nodes can be based on locations, materials, connections, interaction thereof, a combination thereof for the nodes. For example, location based physical characteristics or specifications can be for the nodes within the resource portion 202 relative to an overall shape or geometry of the resource portion 202. As a more specific example, the physical characteristics or specifications can include a location of the resource cluster 208, the resource unit 214, the surrounding section 222, or a combination thereof relative to the central area 204, the outer area 206, or a combination thereof.

Also for example, the location based physical characteristics or specifications can be relative locations of the nodes within the resource portion 202, such as between the resource cluster 208, the resource unit 214, the surrounding section 222, or a combination thereof. As a more specific example, the physical characteristics or specifications can include a separation measure 228, an overlap measure 230, or a combination thereof.

The separation measure 228 can include a representation of a degree of division between the nodes within the resource portion 202. For example, the separation measure 228 can include a distance, an amount of non-functional material or a specific type of circuitry, a strength or a rating of separating or ambient material, a percentage based on a dimension of the resource portion 202, or a combination thereof existing between or separating the resource cluster 208, the resource unit 214, the surrounding section 222, or a combination thereof.

The overlap measure 230 can include a representation of a degree of overlay or intersection along a direction or an axis between the nodes within the resource portion 202. For example, the overlap measure 230 can include a distance, an amount of non-functional material or a specific type of circuitry, a percentage based on a dimension of the resource portion 202, or a combination thereof overlapping between the resource cluster 208, the resource unit 214, the surrounding section 222, or a combination thereof.

The overlap measure 230 can be based on the direction or the axis parallel to a peripheral side or edge of the resource portion 202 or a node therein. The overlap measure 230 can further be based on a reference direction or axis, such as left-right, up-down, forward-backward, x-y-z, or a combination thereof defined for describing the resource portion 202, a component or a device therein, or a combination thereof.

The physical characteristics or specifications based on materials, connections, interaction thereof, a combination thereof is exemplified and discussed below. The computing system 100 can use the physical characteristics or specifications for the resource portion 202 or a node therein to process thermal characteristics.

The thermal characteristics can include thermal resistance-capacitance network 232. The thermal resistance-capacitance network 232 is a representation of a thermal relationship between the nodes within the resource portion 202. The thermal resistance-capacitance network 232 can represent a parasitic thermal load, such as a thermal influence or transfer behavior, between one node and another node. For example, the thermal resistance-capacitance network 232 can represent a change in temperature on one node caused by or in response to a temperature level of another node with physical or location-based association to the node.

The computing system 100 can generate the thermal resistance-capacitance network 232 corresponding to one or more instances of the nodes in the resource portion 202. The computing system 100 can generate the thermal resistance-capacitance network 232 for specifically representing the resource portion 202, such as for each unique instance or type of the SoC or mobile AP. The thermal resistance-capacitance network 232 can represent the thermal relationship between or for the resource cluster 208, the resource unit 214, the surrounding section 222, or a combination thereof of the resource portion 202.

The computing system 100 can generate the thermal resistance-capacitance network 232 based on physical characteristics or specifications of the resource portion 202. The computing system 100 can generate the thermal resistance-capacitance network 232 based on the physical characteristics or specifications corresponding to locations, materials, connections, interaction thereof, a combination thereof for the nodes. Details regarding the processing and use of the thermal characteristics and generation of the thermal resistance-capacitance network 232 are discussed below.

The computing system 100 can further include a power monitor 234. The power monitor 234 can include a device or circuitry configured to measure or estimate present power 236 consumed by a corresponding device or circuitry. The present power 236 can include instantaneous power or an amount or a rate of energy consumed by the corresponding device or circuitry.

The power monitor 234 can further measure or estimate the present power 236 based on a voltage, a current, thermal energy level, a number of instructions or a duration of execution, or a combination thereof measured or estimated for the corresponding device or circuitry. The power monitor 234 can be for measuring or estimating the present power 236 consumed by the corresponding device or circuitry including the resource portion 202, the resource cluster 208, the surrounding section 222, the resource unit 214, or a combination thereof.

For illustrative purposes, the power monitor 234 is shown as being included in the resource portion 202 separate from the first cluster 210, the second cluster 212, and the surrounding section 222. However, it is understood that the power monitor 234 can be configured differently.

For example, the power monitor 234 can be included in the resource portion 202, the resource cluster 208, the surrounding section 222, the resource unit 214, or a combination thereof. Also for example, the power monitor 234 can further be external to the resource portion 202, the resource cluster 208, the surrounding section 222, the resource unit 214, or a combination thereof. As a more specific example, the power monitor 234 can include a grouping of circuitry included or coupled to each of the nodes in the resource portion 202 for measuring or estimating the present power 236 of the each nodes in the resource portion 202.

The computing system 100 can generate a dynamic load profile 238. The dynamic load profile 238 is a representation of execution-related characteristic for the resource portion 202, a node therein, or a combination thereof. The dynamic load profile 238 can include a representation of tasks scheduled for the resource portion 202, a node therein, or a combination thereof. The dynamic load profile 238 can further include a representation of thermal energy associated with the resource portion 202, a node therein, or a combination thereof. For example, the dynamic load profile 238 can include a present thermal load 240, a present work load 242, a present residency time 244, or a combination thereof.

The present thermal load 240 can include an amount of thermal energy associated with a node at time of processing. The present thermal load 240 can represent a run-time temperature of the resource cluster 208, the resource unit 214, the surrounding section 222, or a combination thereof at current time.

The present thermal load 240 can include the thermal energy housed or included in a physical structure of the resource cluster 208, the resource unit 214, the surrounding section 222, or a combination thereof. The present thermal load 240 can be based on ambient temperature along with a previously executed process or instruction, a currently ongoing process or instruction, or a combination thereof executed at or implemented with corresponding instance of the resource cluster 208, the resource unit 214, the surrounding section 222, or a combination thereof.

The present work load 242 can include a process, an instruction, or a combination thereof ongoing or scheduled for the node at the time of processing. The present work load 242 can represent a run-time queue or schedule for a process, an instruction, or a combination thereof for execution at or implementation by the resource cluster 208, the resource unit 214, the surrounding section 222, or a combination thereof at current time.

The present work load 242 can include a trait of the process, the instruction, or a combination thereof. For example, the present work load 242 can include a number or a quantity of individual executable steps, a degree of difficulty, a number of clock cycles, or a combination thereof for the process, the instruction, or a combination thereof.

The present residency time 244 can include a duration required to complete the present work load 242 by the corresponding node. The present residency time 244 can include a total time, a total number of clock cycles, a total number of executable steps, or a combination thereof for completing the present work load 242. The present residency time 244 can further include a remaining time, a remaining number of clock cycles, a remaining number of executable steps, or a combination thereof until completing the present work load 242.

The computing system 100 can generate the dynamic load profile 238 based on variety of methods, processes, factors, models, devices or circuits, or a combination thereof. For example, the computing system 100 can generate the dynamic load profile 238 using a scheduler, the power monitor 234, a method or process predetermined by the computing system 100, a status report of each node, or a combination thereof.

The computing system 100 can use the dynamic load profile 238 to determine a target resource 246 for performing a target task 248. The target task 248 can include an instruction or a process required to be performed or executed by a node in the resource portion 202. The target task 248 can be scheduled to be performed or executed by the target resource 246.

The target resource 246 is a node designated to perform or execute the target task 248. The target resource 246 can be a specific instance of the resource unit 214, such as the first resource 216 or the second resource 218. The computing system 100 can determine the target resource 246 based on the dynamic load profile 238, the present power 236, the thermal resistance-capacitance network 232, or a combination thereof.

The computing system 100 can determine the target resource 246 as the node most appropriate for executing or performing the target task 248 based on the thermal load or requirement associated with the execution or the performance. Details regarding the process for determining and utilizing the target resource 246 are discussed below.

Referring now to FIG. 3, therein is shown an exemplary diagram of a thermal model 302 for the computing system 100. The thermal model 302 is a representation of relationship between temperature or thermal energy and power at one or more nodes. The thermal model 302 can be a model using resistance, capacitance, or a combination thereof corresponding to the one or more nodes. For example, the thermal model 302 can represent a response in temperature at a reference node 304.

The reference node 304 can include an instance of the node being analyzed or processed by the computing system 100. The reference node 304 can include an instance of the resource cluster 208 of FIG. 2 or an instance of the resource unit 214 of FIG. 2. For example, the reference node 304 can include the first resource 216 of FIG. 2 or the second resource 218 of FIG. 2.

The reference node 304 can be coupled to one or more instances of a surrounding node 306. The surrounding node 306 can include an instance of the node in the resource portion 202 of FIG. 2 other than the reference node 304. The surrounding node 306 can affect thermal energy of the reference node 304 and the thermal energy of the surrounding node 306 can be affected by the reference node 304.

The surrounding node 306 can include other unique instance of the resource unit 214 or the resource cluster 208 of FIG. 2, the surrounding section 222 of FIG. 2 or a combination thereof. For example, when the reference node 304 is the first resource 216, the surrounding node 306 can include the resource portion 202 labeled ‘B1’, ‘B2’, ‘B3’, or a combination thereof. Also for example, when the reference node 304 is the first resource 216, the surrounding node 306 can include the second cluster 212 of FIG. 2, the graphics section 224 of FIG. 2, the general section 226 of FIG. 2, or a combination thereof.

The surrounding node 306 can be physically or electrically associated with the reference node 304. For example, the surrounding node 306 can be directly or indirectly coupled or connected to the reference node 304. Also for example, the surrounding node 306 can be a node within a threshold distance from the reference node 304. Also for example, the surrounding node 306 can share a common physical structure or be connected to the reference node 304.

The thermal model 302 can be a model using resistance, capacitance, or a combination thereof corresponding to the reference node 304, the surrounding node 306, or a combination thereof. The computing system 100 can calculate the present thermal load 240 of FIG. 2 using the thermal model 302 and the present power 236 of FIG. 2.

The computing system 100 can account for the present power 236 for the nodes of the resource portion 202. For example, the thermal model 302 can account for the present power 236 of the resource unit 214, the resource cluster 208, the surrounding section 222, or a combination thereof.

The computing system 100 can calculate the present thermal load 240 as a function of time using the thermal model 302. For example, the computing system 100 can calculate the present thermal load 240 based on:

$${T}_{i} ( t ) = [ \frac{{R}_{1 i} Δ t}{2 {R}_{1 i} {C}_{1 i} + Δ t} [ {P}_{1} ( t ) + {P}_{1} ( t - 1 ) ] + \frac{2 {R}_{1 i} {C}_{1 i} - Δ t}{2 {R}_{1 i} {C}_{1 i} + Δ t} * {T}_{i} ( t - 1 ) ] + [ \frac{2 {R}_{2 i} Δ t}{2 {R}_{2 i} {C}_{2 i} + Δ t} [ {P}_{2} ( t ) + {P}_{2} ( t - 1 ) ] + \frac{2 {R}_{2 i} {C}_{2 i} - Δ t}{2 {R}_{2 i} {C}_{2 i} + Δ t} * {T}_{i} ( t - 1 ) ] + … + [ \frac{{R}_{ni} Δ t}{2 {R}_{ni} {C}_{ni} + Δ t} [ {P}_{2} ( t ) + {P}_{2} ( t - 1 ) ] + \frac{2 {R}_{ni} {C}_{ni} - Δ t}{2 {R}_{ni} {C}_{ni} + Δ t} * {T}_{i} ( t - 1 ) ] . \qquad Equation ( 1 )$$

For Equation (1), the present thermal load 240 as a function of time at the reference node 304 designated by ‘i’ can be represented as ‘Tᵢ(t)’. The ‘n’ instances of the surrounding node 306 can be designated by numbers ‘1’ through ‘n’. The present power 236 can be represented as a function of time at node 1 through node n can be represented as ‘P₁’ through ‘Pₙ’. The thermal model 302 can be represented as resistance values corresponding to node 1 through node n, shown as ‘R₁’ through ‘Rₙ’, capacitance values corresponding to node 1 through node n, shown as ‘C₁’ through ‘Cₙ’, or a combination thereof.

The thermal model 302 can account for an active node 308, a resting node 310, or a combination thereof. The active node 308 is a node performing a function at a current time or processing an instruction at the current time. The resting node 310 is a node not performing a function at a current time or processing an instruction at the current time.

The computing system 100 can identify and process the active node 308 and the resting node 310. For example, the computing system 100 can determine the target resource 246 of FIG. 2 as an instance of the resting node 310. Also for example, the computing system 100 can iteratively set the resting node 310 as the reference node 304 for analyzing the resting instances of the resource unit 214 as a candidate for the target resource 246. Also for example, the computing system 100 can set the active node 308, the resting node 310, or a combination thereof as the surrounding node 306.

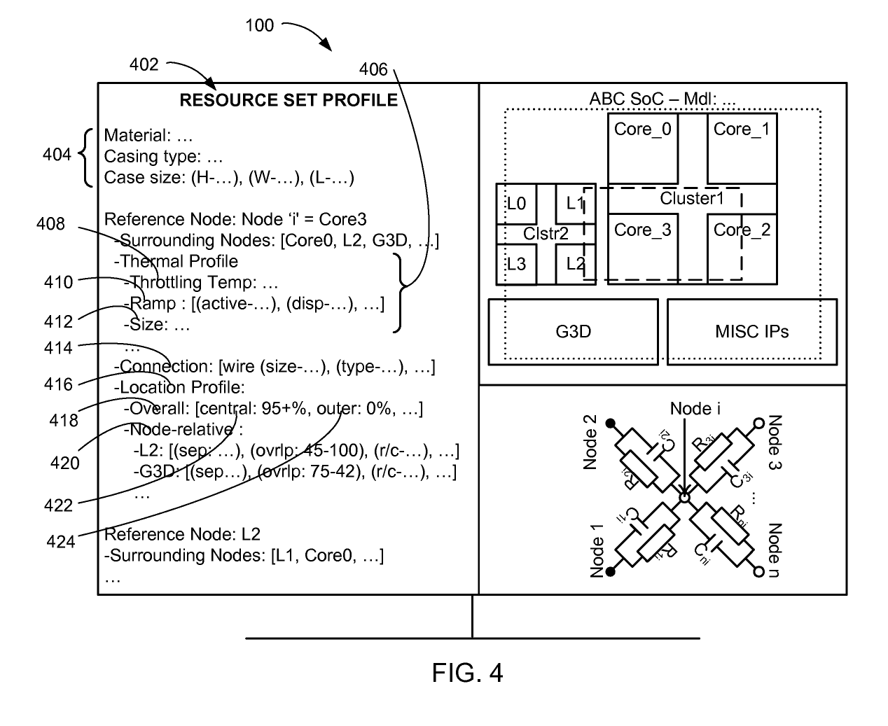

Referring now to FIG. 4, therein is shown an exemplary display of the computing system 100. The computing system 100 can show the exemplary display in a variety of ways. For example, the computing system 100 can show the exemplary display using the display interface 130 or on a further device separate from the device 102 of FIG. 2.

Also for example, the computing system 100 can show the exemplary display in interfacing with a user for generating the thermal resistance-capacitance network 232 of FIG. 2 or the thermal model 302 of FIG. 3, debugging a process or a method for the generation, adjustment thereof, or a combination thereof. Also for example, the computing system 100 can show the exemplary display applicable to designing or manufacturing the resource portion 202 of FIG. 2.

The exemplary display can show a resource set profile 402. The resource set profile 402 is a representation of factors having thermal influence the resource portion 202, a node therein, or a combination thereof. The resource set profile 402 can represent physical or operational characteristics of the resource portion 202 or a portion therein.

The resource set profile 402 can be for representing or determining a thermal characteristic or behavior of the resource portion 202, a node therein, or a combination thereof. The resource set profile 402 can represent the resource portion 202 or the resource cluster 208 of FIG. 2, the resource unit 214 of FIG. 2, the surrounding section 222 of FIG. 2, or a combination thereof within the resource portion 202.

The resource set profile 402 can include an environmental profile 404. The environmental profile 404 can represent factors influencing thermal behavior or characteristic of the nodes caused by or contributed from conditions or material surrounding the nodes.

For example, the environmental profile 404 can include details for, such as material or shape, an encapsulation or a casing. Also for example, the environmental profile 404 can include overall dimensions or density of the resource portion 202. Also for example, the environmental profile 404 can include a use, a location, a quantifiable influence, or a combination thereof of heat-syncs for the resource portion 202. The environmental profile 404 can further include a quantity or a model relating the thermal behavior or characteristic caused by or contributed from such factors.

The resource set profile 402 can further include a unit-thermal profile 406. The unit-thermal profile 406 is a representation of thermally-relevant factors for a node within the resource portion 202. The unit-thermal profile 406 can represent physical or operational characteristics of a corresponding node.

The unit-thermal profile 406 can be for representing or determining a thermal characteristic or behavior of a node, such as a specific instance of the resource portion 202, the resource cluster 208, the resource unit 214, or the surrounding section 222. For example, the unit-thermal profile 406 can include details for the corresponding node, such as material or shape. Also for example, the unit-thermal profile 406 can include a throttling threshold 408, a ramp profile 410, a resource size 412, or a combination thereof.

The throttling threshold 408 can represent a limit on thermal energy for the corresponding node. The throttling threshold 408 can be a maximum temperature level for controlling operation of the node. The throttling threshold 408 can be the thermal limit for optimal or non-damaging operation of the node.

The computing system 100 or the resource portion 202 can change or adjust the operational setting 220 of FIG. 2 at the throttling threshold 408. The operational setting 220 can be changed to reduce the workload or energy spent to complete the work. The reduction in workload or energy can reduce the temperature level, and tradeoff efficiency and performance for integrity and preservation of the node.

The ramp profile 410 can represent a change in thermal energy for a node over time. The ramp profile 410 can represent a self-heating behavior, a heat dissipation behavior, or a combination thereof. For example, the ramp profile 410 can represent a temperature level, a rate of change in temperature, or a combination thereof corresponding to various starting conditions, various instances of the operational setting 220, length or type of operation or action taken by the node, or a combination thereof. The ramp profile 410 can represent a rise in temperature, a drop in temperature, or a combination thereof.

The resource size 412 can represent a physical dimension of the corresponding node. The resource size 412 can include a measurement of length, width, height, or a combination thereof. The resource size 412 can further include a classification, a type, a categorization, or a combination thereof describing the corresponding node or the cluster including the node. For example, the resource size 412 can include a “BIG” or “LITTLE” category identifying the resource cluster 208, the resource unit 214, or a combination thereof.

The resource set profile 402 can further include a connection profile 414. The connection profile 414 can represent connections between nodes. The connection profile 414 can include information regarding electrical connection between nodes. The connection profile 414 can include identification of the nodes or circuits connected to a particular node. The connection profile 414 can further include a size, a type, a material, or a combination thereof for the wire or the path connecting the nodes. The connection profile 414 can represent an influence on the thermal property of the particular node from or caused by the electrical connections.

The unit-thermal profile 406 can further include a location profile 416. The location profile 416 is information regarding the location or placement of the particular node. The location profile 416 can describe the location of the particular node relative to the resource portion 202, other nodes, or a combination thereof. For example, the location profile 416 can include an overall-relative location 418, a node-relative location 424, or a combination thereof.

The overall-relative location 418 is information regarding the location or placement of the particular node in reference to the resource portion 202 or physical boundaries thereof. The overall-relative location 418 can describe the location of the particular node relative to a shape or a specific portion of the structure or layout of the resource portion 202. For example, the overall-relative location 418 can include an overall-central location 420, an overall-outer location 422, or a combination thereof.

The overall-central location 420 is information regarding the location or placement of the particular node in reference to the central area 204 of FIG. 2 for the resource portion 202. The overall-outer location 422 is information regarding the location or placement of the particular node in reference to the outer area 206 of FIG. 2 for the resource portion 202.

The overall-central location 420, the overall-outer location 422, or a combination thereof can include an indication that the particular node is located in the central area 204, the outer area 206, or a combination thereof respectively. The overall-central location 420, the overall-outer location 422, or a combination thereof can further include an amount, a degree, a percentage, or a combination thereof of the particular node included in the central area 204, the outer area 206, or a combination thereof respectively.

As exemplified in FIG. 4, the resource unit 214 labeled “Core_3” can have a location or a placement such that over 95% of the resource unit 214 is within the portion of the resource portion 202 identified as the central area 204. The overall-central location 420 can include an indication that the resource unit 214 is located within the central area 204, a number or a quantity corresponding to 95%, a type or a classification based on the 95%, or a combination thereof.

Continuing with the example, the resource unit 214 labeled “Core_3” can have a location or a placement such that no portion of the resource unit 214 is within the portion of the resource portion 202 identified as the outer area 206. The overall-outer location 422 can include a value or a lack thereof indicating that no part of the resource unit 214 is located within the central area 204.

The node-relative location 424 is information regarding the location or placement of the particular node in reference to other nodes. The node-relative location 424 can describe the location, distance, physical relationship or placement, or a combination thereof between the reference node 304 of FIG. 3 and the surrounding node 306 of FIG. 3.

For example, the node-relative location 424 can include an identification for the surrounding node 306 from the perspective of the reference node 304. Also for example, the node-relative location 424 can include or be based on the separation measure 228 of FIG. 2, the overlap measure 230 of FIG. 2, or a combination thereof between the reference node 304 and the surrounding node 306.

The node-relative location 424 can further include resistive representation, capacitive representation, or a combination thereof for the surrounding node 306. The resistive representation, capacitive representation, or a combination thereof can be from the perspective of the reference node 304.

The computing system 100 can use the resource set profile 402 to generate or calculate the thermal resistance-capacitance network 232 of FIG. 2, the thermal model 302 of FIG. 3, or a combination thereof. Details regarding the use of the resource set profile 402 are discussed below.

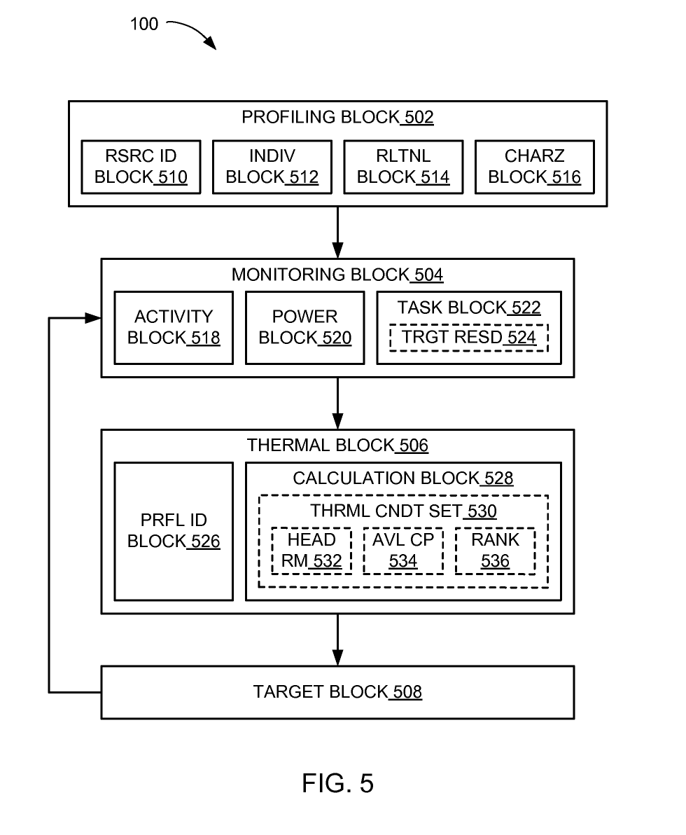

Referring now to FIG. 5, therein is shown a control flow of the computing system 100. The computing system 100 can include a profiling block 502, a monitoring block 504, a thermal block 506, a target block 508, or a combination thereof.

The blocks, buffers, units, or a combination thereof can be coupled to each other in a variety of ways. For example, blocks can be coupled by having the input of one block connected to the output of another, such as by using wired or wireless connections, instructional steps, process sequence, or a combination thereof. Also for example, the blocks, buffers, units, or a combination thereof can be coupled either directly with no intervening structure other than connection means between the directly coupled blocks, buffers, units, or a combination thereof, or indirectly with blocks, buffers, units, or a combination thereof other than the connection means between the indirectly coupled blocks, buffers, units, or a combination thereof.

As a more specific example, one or more inputs or outputs of the monitoring block 504 can be connected to one or more inputs or outputs of the thermal block 506 using conductors or operational connections there-between for direct coupling. Also for example, the monitoring block 504 can be coupled to the thermal block 304 indirectly through other units, blocks, buffers, devices, or a combination thereof. The blocks, buffers, units, or a combination thereof for the computing system 100 can be coupled in similar ways as described above.

Also for example, the profiling block 502 can be on a device different from the monitoring block 504. The profiling block 502 and the monitoring block 504 can be coupled to each other through a non-transitory computer readable medium, a data connection, such as through wires or wireless means, or a combination thereof for exchanging data or signals.

The profiling block 502 is configured to generate or calculate information representing the resource portion 202 of FIG. 2. The profiling block 502 can generate or calculate information representing thermal characteristics or behaviors of the resource portion 202, a node therein, or a combination thereof.

The profiling block 502 can analyze the resource portion 202 for producing the representative output. The profiling block 502 can include a resource identification block 510, an individual modeling block 512, a relational modeling block 514, a characterization block 516, or a combination thereof for analyzing the resource portion 202 and for producing the representative output. The profiling block 502 can generate the resource set profile 402 of FIG. 4, calculate the thermal resistance-capacitance network 232 of FIG. 2, generate the thermal model 302 of FIG. 3, or a combination thereof.

The resource identification block 510 is configured to identify the resource portion 202 or the nodes therein. The resource identification block 510 can identify the resource portion 202 based on determining a name, a type, a category or a classification, a manufacturer information, or a combination thereof identifying the resource portion 202.

The resource identification block 510 can use the user interface 118 of FIG. 1 or a user interface of the further device separate from the device 102 to receive the identification information from the user. The resource identification block 510 can further use the control interface 122 of FIG. 1, the communication interface 128 of FIG. 1, a control or communication interface of the further device, or a combination thereof to communicate or interact with the resource portion 202 to determine the identification information.

The resource identification block 510 can further use identification information of the device including or utilizing the resource portion 202 in a similar way. The resource identification block 510 can identify the resource portion 202 based on identification information correlated with the housing device or the device utilizing the resource portion 202 as predetermined by the computing system 100.

The resource identification block 510 can further identify characteristics of the resource portion 202. The resource identification block 510 can determine the environmental profile 404 of FIG. 4 for identifying characteristics specific to the resource portion 202. The resource identification block 510 can determine the environmental profile 404 based on accessing the environmental profile 404 specifically corresponding to the identification information of the resource portion 202 as predetermined by the computing system 100.

For example, the resource identification block 510 can include a table, a library, or a combination thereof including a specific instance of the environmental profile 404 for each possible or available instances of the resource portion 202. The table, the library, or a combination thereof can be predetermined by the computing system 100, a manufacturer of the resource portion 202, a separate entity, or a combination thereof. The table, the library, or a combination thereof can be stored in the control unit 112 of FIG. 1, the storage unit 114 of FIG. 1, a control or storage unit of the further device or a combination thereof.

Also for example, the resource identification block 510 can access a database, a specification table, or a combination thereof at a location predetermined by the computing system 100. The resource identification block 510 can use the communication unit 116 of FIG. 1, the control interface 122, a corresponding portion of the further device, or a combination thereof to access the database, the specification table, or a combination thereof.

The resource identification block 510 can similarly identify characteristics including the central area 204 of FIG. 2, the outer area 206 of FIG. 2, or a combination thereof for the resource portion 202. The resource identification block 510 can determine the central area 204, the outer area 206, or a combination thereof for identifying specific physical locations or regions within the resource portion 202.

The resource identification block 510 can determine the various areas similar to determining the environmental profile 404. For example, the resource identification block 510 can determine the various areas based on interacting with the user, accessing predetermined tables or libraries, accessing predetermined links or databases, or a combination thereof.

The resource identification block 510 can further identify the resource portion 202 based on identifying nodes, such as circuits, sections, devices, groupings thereof, or a combination thereof, within the resource portion 202. The resource identification block 510 can identify one or more nodes including the resource cluster 208 of FIG. 2, the resource unit 214 of FIG. 2, the surrounding section 222 of FIG. 2, or a combination thereof.

For example, the resource identification block 510 can identify the first cluster 210 of FIG. 2, the second cluster 212 of FIG. 2, the first resource 216 of FIG. 2, the second resource 218 of FIG. 2, the graphics section 224 of FIG. 2, the general section 226 of FIG. 2, or a combination thereof. As a more specific example, the resource identification block 510 can identify based on determining a name, a serial number, a part identifier, a manufacturer identification, an address, or a combination thereof for the nodes including the first cluster 210, the second cluster 212, the first resource 216, the second resource 218, the graphics section 224, the general section 226, or a combination thereof in the resource portion 202.

The resource identification block 510 can locate the nodes within the resource portion 202. The resource identification block 510 can locate the resource cluster 208, the resource unit 214, the surrounding section 222, or a combination thereof relative to the resource portion 202, each other or other nodes, or a combination thereof.

The resource identification block 510 can locate based on determining the separation measure 228 of FIG. 2, the overlap measure 230 of FIG. 2, or a combination thereof. The resource identification block 510 can determine the separation measure 228, the overlap measure 230, or a combination thereof as received from the user, according to predetermined information, received from a measuring device, or a combination thereof. The resource identification block 510 can further calculate the location based on a schematic, a design specification, or a combination thereof.

The resource identification block 510 can generate the location profile 416 of FIG. 4. The resource identification block 510 can generate the location profile 416 based on the location information, such as the separation measure 228, the overlap measure 230, or a combination thereof.

The resource identification block 510 can generate the location profile 416 for describing thermal characteristics or influences according to or based on locations. For example, the resource identification block 510 can generate the location profile 416 including the overall-relative location 418 of FIG. 4, the node-relative location 424 of FIG. 4, the overall-central location 420 of FIG. 4, the overall-outer location 422 of FIG. 4, or a combination thereof.

The resource identification block 510 can identify the nodes, the locations, or a combination thereof similar to determining the environmental profile 404 as described above. For example, the resource identification block 510 can identify the nodes, the locations, or a combination thereof based on interacting with the user, accessing a predetermined table or library, accessing a separate predetermined database or a link, or a combination thereof. Also for example, the resource identification block 510 can process the above described information according to a method or a process predetermined by the computing system 100.

The individual modeling block 512 is configured to generate representation for each of the nodes within the resource portion 202. The individual modeling block 512 can generate the unit-thermal profile 406 of FIG. 4 for representing a characteristic or a behavior of the node by itself or without considering influences from physical surroundings of the node.

The individual modeling block 512 can generate the unit-thermal profile 406 for representing each instance of the resource cluster 208, the resource unit 214, the surrounding node 306 of FIG. 3, or a combination thereof within the resource portion 202. As a more specific example, the individual modeling block 512 can generate the unit-thermal profile 406 for each core in the resource portion 202.

The individual modeling block 512 can generate the unit-thermal profile 406 based on the identification information for each of the nodes determined by the resource identification block 510. The individual modeling block 512 can generate the unit-thermal profile 406 including the throttling threshold 408 of FIG. 4, the ramp profile 410 of FIG. 4, the resource size 412 of FIG. 4, or a combination thereof.

The individual modeling block 512 can further generate the unit-thermal profile 406 based on combining and formatting the various information corresponding to each node. For example, the individual modeling block 512 can generate the unit-thermal profile 406 based combining and formatting the throttling threshold 408, the ramp profile 410, the resource size 412, or a combination thereof.

The individual modeling block 512 can generate the unit-thermal profile 406 similar to the resource identification block 510. For example, the individual modeling block 512 can generate the unit-thermal profile 406 based on interacting with the user, accessing a predetermined table or library, accessing a separate predetermined database or a link, or a combination thereof. Also for example, the resource identification block 510 can process the above described information according to a method or a process predetermined by the computing system 100.

The relational modeling block 514 is configured to generate representation for a grouping of nodes within the resource portion 202. The relational modeling block 514 can generate the resource set profile 402 of FIG. 4 for comprehensively representing a characteristic or a behavior of all the nodes within the resource portion 202.

The relational modeling block 514 can generate the resource set profile 402 for representing a characteristic or a behavior of the nodes as a group, including the interaction, influences, or relationships between the nodes. The relational modeling block 514 can generate the resource set profile 402 for representing a grouping of the resource cluster 208, the resource unit 214, the surrounding node 306, or a combination thereof within the resource portion 202. As a more specific example, the relational modeling block 514 can generate the resource set profile 402 for the cores along with the graphics section 224, the general section 226, or a combination thereof.

The relational modeling block 514 can generate the resource set profile 402 based on identification information for the resource portion 202, the nodes therein, or a combination thereof determined by the resource identification block 510. The relational modeling block 514 can further generate the resource set profile 402 based on the unit-thermal profile 406, the environmental profile 404, or a combination thereof.

The relational modeling block 514 can generate the resource set profile 402 based on determining the location profile 416 of FIG. 4, the connection profile 414 of FIG. 4, or a combination thereof. The relational modeling block 514 can determine the location profile 416 based on determining the overall-relative location 418 of FIG. 4, such as the overall-central location 420 of FIG. 4 or the overall-outer location 422 of FIG. 4, the node-relative location 424 of FIG. 4, or a combination thereof.

The relational modeling block 514 can generate the resource set profile 402 including the node-relative location 424 for locating the nodes relative to each other. The relational modeling block 514 can generate the resource set profile 402 including the node-relative location 424 for locating the multiple nodes relative to the resource portion 202.

The relational modeling block 514 can determine the location profile 416 based on the location information of the nodes from the individual modeling block 512. The relational modeling block 514 can determine the location profile 416 based on identifying nodes in having physical association to each other.

For example, the relational modeling block 514 can determine the location profile 416 based on identifying the surrounding node 306 for each instance of the reference node 304 of FIG. 3. Also for example, the relational modeling block 514 can determine the location profile 416 based on the separation measure 228, the overlap measure 230, or a combination thereof between the reference node 304 and the surrounding node 306.

The relational modeling block 514 can further determine the connection profile 414 based on electrical connections. The relational modeling block 514 can determine the connection profile 414 based on identifying electrical relationship between the nodes of the resource portion 202.

For example, the relational modeling block 514 can determine the connection profile 414 based on identifying a net list describing electrical connections between nodes. Also for example, the relational modeling block 514 can determine the connection profile 414 based on identifying a type or a size of wires or conductive paths, heat syncs, a distance between nodes, or a combination thereof.

The relational modeling block 514 can generate the resource set profile 402 based on combining and formatting the various information corresponding to the grouping of the nodes. For example, the individual modeling block 512 can generate the resource set profile 402 based combining and formatting the environmental profile 404, one or more instances of the unit-thermal profile 406 each corresponding to a node, the connection profile 414, the location profile 416, or a combination thereof.

The relational modeling block 514 can generate the resource set profile 402, including determining the location profile 416 or the connection profile 414, similar to the resource identification block 510. For example, the relational modeling block 514 can generate the resource set profile 402 based on interacting with the user, accessing a predetermined table or library, accessing a separate predetermined database or a link, or a combination thereof. Also for example, the relational modeling block 514 can process the above described information according to a method or a process predetermined by the computing system 100.

The characterization block 516 is configured to generate a representation of influences and relationships between nodes. The characterization block 516 can generate the representation of influences and relationships in thermal energy between nodes. For example, the characterization block 516 can generate information describing effect of heat level of one node on another. Also for example, the characterization block 516 can generate information for estimating or calculating an amount of thermal energy at the node.

The characterization block 516 can generate the representation by calculating the thermal resistance-capacitance network 232 of FIG. 2, generating the thermal model 302 of FIG. 3, or a combination thereof. The characterization block 516 can calculate the thermal resistance-capacitance network 232 for representing thermal interactions between the nodes.

The characterization block 516 can calculate the thermal resistance-capacitance network 232 for determining the target resource 246 of FIG. 2 to perform the target task 248 of FIG. 2. The characterization block 516 can generate the thermal model 302 for representing a temperature level corresponding to the present power 236 of FIG. 2 of the nodes.

The characterization block 516 can calculate the thermal resistance-capacitance network 232 for each node as the reference node 304. The characterization block 516 can calculate the thermal resistance-capacitance network 232 between the reference node 304 and the surrounding node 306. As a more specific example, the characterization block 516 can calculate the thermal resistance-capacitance network 232 between an instance of the resource unit 214 and another instance of the resource unit 214, the resource cluster 208, the surrounding section 222, or a combination thereof.

The characterization block 516 can calculate the thermal resistance-capacitance network 232 based on the resource set profile 402. For example, the characterization block 516 can calculate the thermal resistance-capacitance network 232 based on the unit-thermal profile 406, the environmental profile 404, the connection profile 414, the location profile 416, or a combination thereof.

The characterization block 516 can calculate the thermal resistance-capacitance network 232 according to a temperature transfer model, an equation, a process, a method, or a combination thereof predetermined by the computing system 100. The characterization block 516 can calculate the thermal resistance-capacitance network 232 using the unit-thermal profile 406, the environmental profile 404, the thermal profile 414, the location profile 416, or a combination thereof as input to the predetermined model, equation, process, method, or a combination thereof.

For example, the characterization block 516 can calculate the thermal resistance-capacitance network 232 based on material or heat transfer characteristic thereof according to the environmental profile 404. Also for example, the characterization block 516 can calculate the thermal resistance-capacitance network 232 based on heat transfer influence or heat dissipation characteristic of the wires or conductive paths.

Also for example, the characterization block 516 can calculate the thermal resistance-capacitance network 232 based on the overall-relative location 418, the node-relative location 424, or a combination thereof. The characterization block 516 can calculate the thermal resistance-capacitance network 232 based on heat transfer influence or heat dissipation characteristic of the separation measure 228, the overlap measure 230, or a combination thereof between the reference node 304 and the surrounding node 306.

The characterization block 516 can further generate the thermal model 302 based on the resource set profile 402. The characterization block 516 can generate the thermal model 302 according to a temperature transfer model, an equation, a process, a method, or a combination thereof predetermined by the computing system 100.

The characterization block 516 can generate the thermal model 302 using the unit-thermal profile 406, the environmental profile 404, the connection profile 414, the location profile 416, or a combination thereof as input to the predetermined model, equation, process, method, or a combination thereof. For example, the characterization block 516 can generate the thermal model 302 based on electrical resistance, capacitance, or a combination thereof according to materials of the nodes, distances between or relative physical arrangements of the nodes, or a combination thereof.

The profiling block 502 can generate or calculate information representing the resource portion 202 using the control unit 112, the user interface 118, the communication unit 116, a unit in the further device, or a combination thereof. The profiling block 502 can store the representations, such as the thermal resistance-capacitance network 232, the thermal model 302, or a combination thereof in the control unit 112, the resource portion 202, the storage unit 114, a storage unit in the further device or separate from the device 102, or a combination thereof.

After calculating or generating the representations, the control flow can pass to the monitoring block 504. The control flow can pass through a variety of ways. For example, control flow can pass by having processing results of one block passed to another block, such as by passing the processing result from the profiling block 502 to the monitoring block 504.

Also for example, the control flow can pass by storing the processing results at a location known and accessible to the other block, such as by storing the thermal resistance-capacitance network 232 or the thermal model 302 corresponding to the resource portion 202, at a storage location known and accessible to the monitoring block 504. Also for example, the control flow can pass by notifying the other block, such as by using a flag, an interrupt, a status signal, or a combination thereof.

The computing system 100 can further include the profiling block 502 implemented as the further device separate from the device 102, the resource portion 202, or a combination thereof. For example, the profiling block 502 can include a design tool, an analysis tool, a manufacturing equipment, or a combination thereof for designing, analyzing, manufacturing, or a combination thereof for the resource portion 202.

It has been discovered that the thermal resistance-capacitance network 232 between the nodes specific to the resource portion 202 provides improved performance of the resource portion 202 with respect to thermal limitations during run-time. The thermal resistance-capacitance network 232 between the nodes can be used to characterize the thermal influence from one node to another during run-time, which can be used to accurately measure, estimate, or predict the thermal energy at a node while accounting for influences from other nodes.

The monitoring block 504 is configured to identify a present state of the resource portion 202. The monitoring block 504 can identify the present state by identifying states, activities, traits, or a combination thereof for the nodes within the resource portion 202. For example, the monitoring block 504 can include an activity block 518, a power block 520, a task block 522, or a combination thereof to identify the present state of the resource portion 202.

The activity block 518 is configured to determine an activity status of the nodes. The activity block 518 can determine the activity status by identifying the active node 308 of FIG. 3, the resting node 310 of FIG. 3, or a combination thereof among the nodes. For example, the activity block 518 can determine the resource cluster 208, the resource unit 214, the surrounding section 222, or a combination thereof as the active node 308 or the resting node 310.

The activity block 518 can identify the active node 308, the resting node 310, or a combination thereof in a variety of ways. For example, the activity block 518 can identify a node as being active or resting based on information from a task scheduler controlling work or task for the nodes. Also for example, the activity block 518 can identify a node as being active or resting based on polling or interfacing with the node.

Also for example, the activity block 518 can identify a node as being active or resting based on energy consumption, such as voltage, current, or power reading. As a more specific example, the activity block 518 can identify the active node 308 when the power monitor 234 of FIG. 2 corresponding to the node indicates the present power 236 of FIG. 2 for the node above a threshold amount.

The power block 520 is configured to determine the energy consumption of the nodes. The power block 520 can determine the energy consumption by calculating the present power 236 for each node. For example, the power block 520 can calculate the present power 236 for each instance of the resource cluster 208, the resource unit 214, the surrounding section 222, or a combination thereof.

The power block 520 can calculate the present power 236 in a variety of ways. For example, the power block 520 can calculate the present power 236 using the power monitor 234. The power monitor 234 can directly measure or calculate the voltage, the current, or a combination thereof instantaneously used for the corresponding node. The power monitor 234 can calculate the instantaneous power consumed by the corresponding node based on the voltage, the current, or a combination thereof.

Also for example, the power block 520 can calculate the present power 236 using the task scheduler. The power block 520 can determine the task presently being performed by the corresponding node using the task scheduler. The power block 520 can estimate the instantaneous power being consumed according to the task being performed by the corresponding node. The power monitor 234 can use various power estimates each specific to a unique task, a unique node, or a combination thereof as predetermined by the computing system 100.

The power block 520 can calculate the present power 236 for all nodes within the resource portion 202. The power block 520 can also calculate the present power 236 for all instances of the active node 308 without calculating the present power 236 for the resting node 310.

The task block 522 is configured to determine information regarding the work to be performed at one of the nodes. The task block 522 can determine information regarding the future work by identifying the target task 248. The task block 522 can identify the target task 248 that needs to be scheduled. The task block 522 can identify the target task 248 that will be performed using the target resource 246.

The task block 522 can identify the target task 248 in a variety of ways. For example, the task block 522 can identify the target task 248 based on information from a task scheduler controlling work or task, or assignment thereof.

Also for example, the task block 522 can identify the target task 248 based on the software 126 of FIG. 1, the application, a process or a thread thereof, or a combination thereof applicable to or in execution at the present time. As a more specific example, the task block 522 can identify the target task 248 based on identify upcoming or subsequent instance of the instruction or the step for the software 126, the application, a process or a thread thereof, or a combination thereof. Also as a more specific example, the task block 522 can identify the target task 248 based on estimating upcoming or subsequent instance of the instruction or the step.

The task block 522 can further calculate a target residency time 524 for performing the target task 248. The target residency time 524 is a representation of a duration required to complete the target task 248. The target residency time 524 can be an amount of time of cycles required for implementing and finishing the target task 248. The target residency time 524 can be specific to the node, the operational setting 220 of FIG. 2 thereof, or a combination thereof.

The task block 522 can calculate the target residency time 524 corresponding to the target task 248 similarly as described above. For example, the task block 522 can use an equation, a method, a process predetermined by the computing system 100 for calculating or estimating the target residency time 524 corresponding to the target task 248. Also for example, the task block 522 can use values predetermined specifically for different instances of the task to calculate the target residency time 524.

The monitoring block 504 can use the control unit 112, the resource portion 202, the storage unit 114, a portion or a circuitry therein, or a combination thereof to identify the present state of the resource portion 202. The monitoring block 504 can store the information regarding the present state, such as the active node 308 or the resting node 310, the present power 236, the target task 248, the target residency time 524, or a combination thereof in the control unit 112, the resource portion 202, the storage unit 114, a portion or a circuitry therein, or a combination thereof.

After identifying the present state, the control flow can pass to the thermal block 506. The control flow can be passed similarly as described above between the profiling block 502 and the monitoring block 504, but using processing results of the monitoring block 504, such as identification of the active node 308 or the resting node 310, the present power 236, the target task 248, the target residency time 524, or a combination thereof.

The thermal block 506 is configured to calculate information regarding thermal energy for the resource portion 202. The thermal block 506 can identify the thermal characteristics or behavior specific to the resource portion 202.

The thermal block 506 can calculate or estimate present level of thermal energy for the resource portion 202 or a node therein. The thermal block 506 can further determine relative information for the nodes regarding the thermal energy. The thermal block 506 can include a profile identification block 526, a calculation block 528, or a combination thereof for calculating the thermal information.

The profile identification block 526 is configured to determine characteristics or behaviors relevant to the resource portion 202 or a node therein. The profile identification block 526 can determine thermal characteristics or behaviors relevant to assigning the target task 248. For example, the profile identification block 526 can identify the throttling threshold 408, determine the thermal resistance-capacitance network 232, determine the thermal model 302, or a combination thereof for the nodes of the resource portion 202.

The profile identification block 526 can determine the characteristics or behaviors for each of the nodes based on iteratively setting one of the nodes as the reference node 304. The profile identification block 526 can identify the throttling threshold 408, determine the thermal resistance-capacitance network 232, determine the thermal model 302, or a combination thereof corresponding to each instance of the reference node 304.

The profile identification block 526 can further identify the throttling threshold 408, determine the thermal resistance-capacitance network 232, determine the thermal model 302, or a combination thereof corresponding to each instance of the reference node 304 identified as the resting node 310. The profile identification block 526 can further identify the throttling threshold 408, determine the thermal resistance-capacitance network 232, determine the thermal model 302, or a combination thereof corresponding to the resource unit 214.

The profile identification block 526 can determine the thermal resistance-capacitance network 232 for representing thermal interactions between the reference node 304 and the surrounding node 306. The profile identification block 526 can determine the thermal model 302 for representing the present thermal load 240 of FIG. 2 corresponding to the present power 236 of the reference node 304, the surrounding node 306, or a combination thereof.

The profile identification block 526 can further identify the throttling threshold 408, determine the thermal resistance-capacitance network 232, determine the thermal model 302, or a combination thereof stored in the control unit 112, the storage unit 114, the resource portion 202, or a combination thereof. The profile identification block 526 can access the throttling threshold 408, the thermal resistance-capacitance network 232, the thermal model 302, or a combination thereof as generated and stored by the profiling block 502. The profile identification block 526 can access the throttling threshold 408, the thermal resistance-capacitance network 232, the thermal model 302, or a combination thereof for the reference node 304 based on a method, a process, a circuitry, a location, or a combination thereof predetermined by the computing system 100.

The calculation block 528 is configured to dynamically calculate information regarding thermal energy for the resource portion 202. The calculation block 528 can dynamically calculate information based on the present state of the resource portion 202 and the characteristics or behaviors relevant to the resource portion 202.

The calculation block 528 can dynamically calculate the information in real-time. The calculation block 528 can dynamically calculate according to the levels, characteristics, circumstances, conditions, or a combination thereof at the present time for the resource portion 202 or a node therein.

The calculation block 528 can dynamically calculate the present thermal load 240 for the nodes. The calculation block 528 can further dynamically calculate the present thermal load 240 based on the present power 236 of the nodes. For example, the calculation block 528 can dynamically calculate the present thermal load 240 for instances of the resting node 310. Also for example, the calculation block 528 can also dynamically calculate the present thermal load 240 based on the present power 236 of the active node 308, the surrounding node 306, or a combination thereof.

The calculation block 528 can dynamically calculate the present thermal load 240 for each instance of the reference node 304 based on the thermal model 302. The calculation block 528 can dynamically calculate the present thermal load 240 for the reference node 304 according to the thermal model 302 accounting for thermal influences from instances of the surrounding node 306 corresponding to the present thermal load 240.

As a more specific example, the calculation block 528 can dynamically calculate the present thermal load 240 for the reference node 304 corresponding to the resource unit 214 and resting node 310. The calculation block 528 can calculate the present thermal load 240 effected by the surrounding node 306 including the active node 308 consuming the present power 236.

The calculation block 528 can calculate the present thermal load 240 of the reference node 304 using the thermal model 302 of the reference node 304. The calculation block 528 can calculate the present thermal load 240 with the present power 236 of each instance of the surrounding node 306 as input to the thermal model 302.

The calculation block 528 can dynamically determine the ramp profile 410 corresponding to each instance of the reference node 304, the surrounding node 306, or a combination thereof. The calculation block 528 can dynamically determine the ramp profile 410 corresponding to the present thermal load 240, the present power 236, or a combination thereof for each instance of the reference node 304, the surrounding node 306, or a combination thereof.

The calculation block 528 can determine the ramp profile 410 for describing changes to the present thermal load 240 over time. The calculation block 528 can determine the ramp profile 410 corresponding to a combination of the thermal resistance-capacitance network 232 and the present power 236. As a more specific example, the calculation block 528 can determine the ramp profile 410 corresponding to a ratio between the thermal resistance-capacitance network 232 for the reference node 304, and the surrounding node 306 and the present power 236 of the surrounding node 306.

The calculation block 528 can dynamically calculate a thermal candidate set 530, including or based on a thermal headroom 532, an available capacity 534, a resource ranking 536, or a combination thereof. The calculation block 528 can dynamically calculate the thermal candidate set 530 for representing the present thermal load 240 for the nodes.

For example, the calculation block 528 can dynamically calculate the thermal candidate set 530 for representing the present thermal load 240 or a capacity to perform the target task 248 for the resource unit 214 of the resource portion 202. Also for example, the calculation block 528 can dynamically calculate the thermal candidate set 530 for representing the present thermal load 240 or a capacity to perform the target task 248 for the resting node 310 influenced by the active node 308, the surrounding node 306, or a combination thereof.

The thermal headroom 532 is a representation of available thermal capacity for the node. The thermal headroom 532 can represent a thermal expenditure available for the node before the throttling threshold 408.

The calculation block 528 can dynamically calculate the thermal headroom 532 based on a difference between the throttling threshold 408, the present power 236, or a combination thereof and the present thermal load 240 of the nodes. For example, the calculation block 528 can dynamically calculate the thermal headroom 532 for one or more instances of the resource unit 214. Also for example, the calculation block 528 can dynamically calculate the thermal headroom 532 for corresponding instance of the reference node 304 including the resting node 310.

As a more specific example, the calculation block 528 can dynamically calculate the thermal headroom 532 as a difference between the present thermal load 240 of the reference node 304, accounting for the thermal inputs from the surrounding node 306 with the present power 236, and the throttling threshold 408 of the reference node 304. The calculation block 528 can dynamically calculate the thermal headroom 532 for the reference node 304 corresponding to instances of the resource unit 214 identified as the resting node 310.

The available capacity 534 is a representation of an amount of work available for execution or implementation at a described node. The available capacity 534 can represent a time or a number of cycles from the present state before thermal energy of the described node reaches the throttling threshold 408 when performing a task or an instruction.

The available capacity 534 can represent a duration until the reference node 304 reaches the throttling threshold 408 if the reference node 304 starts executing or implementing a task or an instruction. The available capacity 534 can account for the present thermal load 240 of the reference node 304, the surrounding node 306, or a combination thereof. The available capacity 534 can further account for the present thermal load 240, the present power 236, an influence thereof to the reference node 304, or a combination thereof projected or expected after the present time for the surrounding node 306.

The calculation block 528 can calculate the available capacity 534 based on the thermal headroom 532, the ramp profile 410, or a combination thereof. The calculation block 528 can calculate the available capacity 534 based on the present power 236, the present thermal load 240, the thermal resistance-capacitance network 232, the thermal model 302, the throttling threshold 408, the resource size 412, or a combination thereof for the reference node 304, the surrounding node 306, or a combination thereof.

As a more specific example, the calculation block 528 can calculate the available capacity 534 based on:

t=(T_{threshold}−Tᵢ(t))Σₖ₌₀ⁿCₖ/Pₖ. Equation (2).

The throttling threshold 408 of the reference node 304, represented as ‘i’, can include a temperature level represented as ‘T_{threshold}’. The present thermal load 240 can include a function of time returning a temperature level for the reference node 304 represented as ‘Tᵢ(t)’. The thermal headroom 532 can be represented as ‘T_{threshold}−Tᵢ(t)’.

Continuing with the example, the thermal resistance-capacitance network 232 can be between the reference node 304 and an instance of the surrounding node 306, represented as ‘k=0, 1, 2, . . . , n’. The thermal resistance-capacitance network 232 corresponding to cross heating term can be represented as ‘Cₖ’. The present power 236 of the surrounding node 306 can be represented as ‘Pₖ’. The available capacity 534 can be represented as ‘t’.

Also as a more specific example, the calculation block 528 can calculate the available capacity 534 based on combining Equation (2) with the ramp profile 410 of the reference node 304. The ramp profile 410 of the reference node 304 can be represented as ‘Cᵢ’.

Also as a more specific example, the calculation block 528 can calculate the available capacity 534 based on the present power 236 of the surrounding node 306 as a function of time describing power levels at the surrounding node 306. Also as a more specific example, the calculation block 528 can calculate the available capacity 534 based on Equation (2) modified to include derivatives, integrals, or a combination thereof for describing changes in temperature over time.

The thermal candidate set 530 is an identification of the nodes capable of performing the target task 248. The thermal candidate set 530 can identify the resource unit 214 for performing the target task 248. The thermal candidate set 530 can further identify the resting node 310 for performing the target task 248. The thermal candidate set 530 can also identify the active node 308 for performing the target task 248 for certain conditions.

The calculation block 528 can calculate the thermal candidate set 530 based on a name, an address, a path, or a combination thereof for identifying the candidate node. The calculation block 528 can calculate the thermal candidate set 530 for representing the present thermal load 240 of the nodes, including nodes qualifying as candidates for performing or implementing the target task 248.

The calculation block 528 can calculate the thermal candidate set 530 based on the present power 236, the thermal candidate set 530, the thermal resistance-capacitance network 232, the thermal model 302, throttling threshold 408, or a combination thereof. The calculation block 528 can further calculate the thermal candidate set 530 based on the available capacity 534, the thermal headroom 532, the dynamic load profile 238 of FIG. 2, the target residency time 524, or a combination thereof. The calculation block 528 can include the reference node 304 satisfying predetermined conditions, such as regarding the various parameters or measures described above, into the thermal candidate set 530.

For example, the calculation block 528 can calculate the thermal candidate set 530 including instances of the reference node 304 corresponding to the resource unit 214. Also for example, the calculation block 528 can calculate the thermal candidate set 530 including instances of the reference node 304 corresponding to the resting node 310. The calculation block 528 can calculate the thermal candidate set 530 including the resting node 310 influenced by the active node 308, the surrounding node 306, or a combination thereof.

Also for example, the calculation block 528 can calculate the thermal candidate set 530 including instances of the reference node 304 with the available capacity 534, the thermal headroom 532, or a combination thereof greater than zero according to Equation (2). Also for example, the calculation block 528 can calculate the thermal candidate set 530 including instances of the reference node 304 corresponding to a combination of the ramp profile 410, the present thermal load 240, and the target residency time 524 below the throttling threshold 408.

The calculation block 528 can calculate the thermal candidate set 530 by generating or combining a list, a table, a grouping, or a combination thereof for identification or access for qualifying nodes. The calculation block 528 can calculate the thermal candidate set 530 including the corresponding instances of the thermal headroom 532, the available capacity 534, or a combination thereof.

The resource ranking 536 is an organization for the nodes in the thermal candidate set 530 for performing the target task 248. The resource ranking 536 can include an order or a value for each node relative to others in the thermal candidate set 530. The resource ranking 536 can further include a sequencing or a specific placement for a node within the thermal candidate set 530 relative to other nodes.

The calculation block 528 can dynamically calculate the thermal candidate set 530 based on the available capacity 534. The calculation block 528 can calculate the thermal candidate set 530 including or according to the resource ranking 536 based on the available capacity 534, the present power 236, or a combination hereof. The calculation block 528 can calculate the resource ranking 536 based on a sequence or an order according to the available capacity 534.

The calculation block 528 can dynamically calculate the resource ranking 536 for balancing various factors according to present context. For example, the calculation block 528 can dynamically calculate the resource ranking 536 for balancing power consumption and processing capacity.

As a more specific example, the calculation block 528 can optimize for the processing capacity while increasing rate of power consumption, such as in activating the resting core instead of waiting for the active core to finish, activating a “big” core instead of a “little” core, activating a resting cluster, or a combination thereof. Also as a more specific example, the calculation block 528 can optimize for and reduce the power consumption while reducing the processing capacity, such as in waiting for the active core to finish and then perform the target task 248 instead of activating the resting core, activating a “little” core instead of the “big” core, activating a core in a cluster with other active nodes instead of a resting core, or a combination thereof.

Also for example, the calculation block 528 can dynamically calculate the resource ranking 536 based on parameters or indicators corresponding to the present context. As a more specific example, the calculation block 528 can dynamically calculate the resource ranking 536 using an amount of remaining power of the device 102, an importance or severity of the target task 248, upcoming schedule or task beyond the target task 248, importance or severity of other tasks contemporaneous with the target task 248, or a combination thereof.

The calculation block 528 can include a method, a process, an equation, or a combination thereof predetermined by the computing system 100 for calculating the resource ranking 536. The calculation block 528 can include the predetermined method, process, equation, or a combination thereof balancing the parameters, accounting for various contextual inputs, or a combination thereof.

The calculation block 528 can further dynamically calculate the thermal candidate set 530 based on the present power 236 and the thermal resistance-capacitance network 232. The calculation block 528 can calculate the thermal candidate set 530 including the resource ranking 536 corresponding to the reference node 304 accounting for an influence from the surrounding node 306. The calculation block 528 can account for the influence from the surrounding node 306 based on the present power 236 of the surrounding node 306 and the thermal resistance-capacitance network 232 between the reference node 304 and the surrounding node 306.

The calculation block 528 can further dynamically calculate the thermal candidate set 530 based on the throttling threshold 408 and the present thermal load 240. The calculation block 528 can dynamically calculate the thermal candidate set 530 based on the available capacity 534 calculated using the throttling threshold 408 and the present thermal load 240, or the thermal headroom 532.

The calculation block 528 can further calculate the thermal candidate set 530 with a primary set and a secondary set. The calculation block 528 can include the nodes fitting the qualification criteria as discussed above in the primary set. The calculation block 528 can include the nodes not fitting the qualification criteria in the secondary set. The calculation block 528 can calculate the thermal candidate set 530 with the primary set, the secondary set, or a combination thereof including the resource ranking 536.

The thermal block 506 can use the control unit 112, the resource portion 202, the storage unit 114, a portion or a circuitry therein, or a combination thereof to calculate information regarding thermal energy. The thermal block 506 can store the thermal candidate set 530, the resource ranking 536, the available capacity 534, the thermal headroom 532, or a combination thereof in the control unit 112, the resource portion 202, the storage unit 114, a portion or a circuitry therein, or a combination thereof.

After calculating information regarding thermal energy, the control flow can pass to the target block 508. The control flow can be passed similarly as described above between the profiling block 502 and the monitoring block 504, but using processing results of the thermal block 506, such as the thermal candidate set 530, the resource ranking 536, the available capacity 534, the thermal headroom 532, or a combination thereof.

The target block 508 is configured to assign the target task 248 to a specific node. The target block 508 can assign the target task 248 to a node optimal for performing the target task 248. The target block 508 can assign the target task 248 to the node thermally optimal for performing the target task 248.

The target block 508 can assign the target task 248 by determining the target resource 246. The target block 508 can determine the target resource 246 based on the thermal candidate set 530 for performing the target task 248 using the target resource 246.

The target block 508 can determine the target resource 246 as a specific type of node. For example, the target block 508 can determine the target resource 246 as an instance of the resource unit 214. Also for example, the target block 508 can determine the target resource 246 from among instances of the resting node 310. The target block 508 can eliminate or ignore any instances of the active node 308 included in the thermal candidate set 530 in consideration for the target resource 246.

The target block 508 can further determine the target resource 246 corresponding to greatest instance of the thermal headroom 532 among the nodes in the thermal candidate set 530. For example, the target block 508 can determine the target resource 246 as the most optimal instance, such as the highest or lowest according to a basis of ranking, based on the resource ranking 536 of the thermal candidate set 530.

Also for example, the target block 508 can determine the target resource 246 based on the available capacity 534. The target block 508 can determine the target resource 246 as the node corresponding to maximum instance of the available capacity 534 in the thermal candidate set 530.

The target block 508 can further determine the target resource 246 based on the ramp profile 410 and the target residency time 524. The target block 508 can determine the target resource 246 as a node with a combination of the ramp profile 410, the target residency time 524, the present thermal load 240, the thermal resistance-capacitance network 232, or a combination thereof below the throttling threshold 408.

For example, the target block 508 can ignore or eliminate the nodes that would exceed the throttling threshold 408 when working or executing for the target residency time 524 from the present thermal load 240 according to the ramp profile 410 and the thermal resistance-capacitance network 232. Also for example, the target block 508 can ignore or eliminate the nodes corresponding to negative value of the available capacity 534 according to Equation (2) above. The target block 508 can determine the target resource 246 as the node with optimal thermal conditions from the set of nodes that would be blow the throttling threshold 408 after performing or executing the target task 248.

Also for example, the target block 508 can separately identify the nodes that would exceed the throttling threshold 408. The target block 508 can determine the target resource 246 as the node with optimal conditions from the separately identified nodes when all of the resource units will exceed the throttling threshold 408 in performing or executing the target task 248.

The target block 508 can use the control unit 112, the resource portion 202, the storage unit 114, a portion or a circuitry therein, or a combination thereof to assign the target task 248 to a specific node. The target block 508 can store the assignment information in the control unit 112, the resource portion 202, the storage unit 114, a portion or a circuitry therein, or a combination thereof.

After assigning the target task 248, the control flow can pass to the monitoring block 504. The control flow can be passed similarly as described above between the profiling block 502 and the monitoring block 504, but using processing results of the target block 508, such as the target resource 246.

The computing system 100 can update the current state of the resource portion 202 with the monitoring block 504 based on the target resource 246. The computing system 100 can repeat the process or pass the control flow from the target block 508 to the monitoring block 504 based on a predetermined period of time or a predetermined number of cycles. The computing system 100 can update the current state and designate the target resource 246 according to the predetermined duration. The computing system 100 can further update each time an instance of the target task 248 becomes available.

It has been discovered that the thermal candidate set 530 dynamically calculated based on the available capacity 534 from the present power 236 for representing the present thermal load 240 provides improved performance with respect to thermal limitations. The thermal candidate set 530 representing the thermal load can provide analysis of for thermal capacity of cores in performing upcoming tasks. The thermal candidate set 530 can reduce thermal overloading and subsequent throttling, which can improve the overall performance. The thermal candidate set 530 dynamically calculated based on the present power 236 can increase the relevance and accuracy of the thermal candidate set 530, which can further reduce the thermal overloading.

It has further been discovered that the target resource 246 based on the thermal candidate set 530 based on the available capacity 534 according to the thermal resistance-capacitance network 232 provides increased accuracy in modeling the thermal behavior leading to efficient assignment of nodes. The thermal resistance-capacitance network 232 can account for parasitic dynamically changing heat load from other nodes, increasing the accuracy of the available capacity 534. The increased accuracy in the available capacity 534 can lead to selecting the core with most thermal headroom, which can reduce the throttling.

It has further been discovered that the thermal candidate set 530 dynamically calculated based on the thermal headroom 532 provides improved efficiency in managing the resource portion 202. The dynamic calculation of the thermal candidate set 530 based on the thermal headroom 532 for the present situation can represent dynamic heat load on the cores or a method to estimate the residency in a given performance state. The real-time measurement or estimation of the heat load on the cores, which can be used to determine the target resource 246 appropriate for the target task 248 for the present situation.

It has further been discovered that the thermal candidate set 530 representing only the nodes satisfying a predetermined condition as discussed above provides reduction in complexity and data size. The thermal candidate set 530 representing only limited number of nodes fitting the predetermined condition, such as positive value for the available capacity 534 or the resting node 310, reduces the total number of resources tracked or listed by the thermal candidate set 530.

It has further been discovered that the thermal candidate set 530 including the resource ranking 536 for balancing power and performance according to present contextual parameters provides increased relevancy and usability of the device 102 for the user. The computing system can accurately calculate the target resource 246 most appropriate for the user's need according to most current information based on the thermal candidate set 530 with the resource ranking 536.

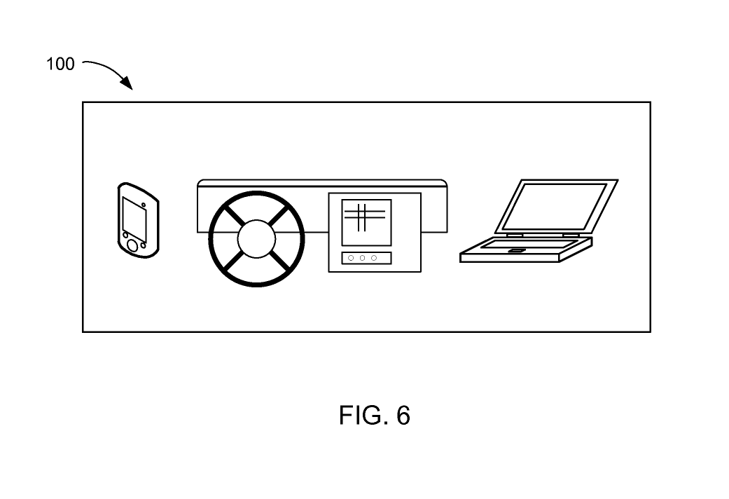

Referring now to FIG. 6, therein is shown examples of the computing system 100 as application examples with the embodiment of the present invention. FIG. 6 depicts various embodiments, as examples, for the computing system 100, such as a smart phone, a dash board of an automobile, and a notebook computer, as example examples with embodiments of the present invention. These application examples illustrate the importance of the various embodiments of the present invention to provide optimal processing performance while minimizing thermal energy for the nodes of the resource portion 202 of FIG. 2 overall.

In an example where an embodiment of the present invention is an integrated circuit processor or a SoC. The blocks described above are embedded therein, various embodiments of the present invention can reduce overall time, power, or a combination thereof required for accessing instructions or data while reducing penalties from misses for improved performance of the processor.

The computing system 100, such as the smart phone, the dash board, one or a collection of IoT components, a server, and the notebook computer, can include a one or more of a subsystem (not shown), such as a printed circuit board having various embodiments of the present invention or an electronic assembly having various embodiments of the present invention. The computing system 100 can also be implemented as an adapter card.

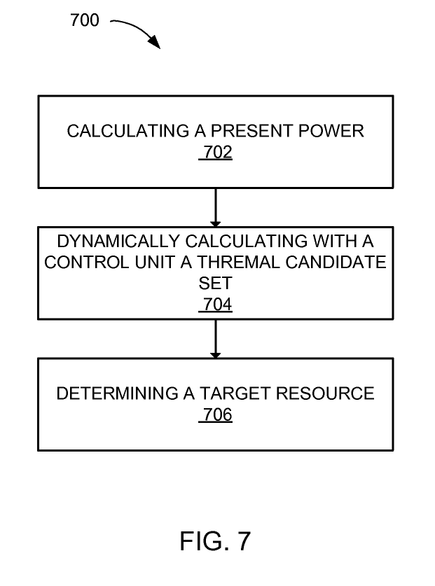

Referring now to FIG. 7, therein is shown a flow chart of a method 500 of operation of a computing system 100 in an embodiment of the present invention. The method 700 includes: calculating a present power for each of multiple resource units in a block 702; dynamically calculating with a control unit a thermal candidate set based on the present power, the thermal candidate set for representing a present thermal load for the multiple resource units in a block 704; and determining a target resource based on the thermal candidate set for performing a target task using the target resource in a block 706.

The block 704 further includes: dynamically calculating a thermal headroom corresponding to the multiple resource units; dynamically determining a ramp profile corresponding to each of the multiple resource units for describing changes to the present thermal load over time; determining a thermal resistance-capacitance network for representing thermal interactions between the multiple resource units; dynamically calculating the thermal candidate set based on the present power and the thermal resistance-capacitance network; determining a thermal model for representing the present thermal load corresponding to the present power of the multiple resource units; dynamically calculating the thermal candidate set based on the thermal model; or a combination thereof.

The block 706 further includes: determining the target resource corresponding to greatest instance of the thermal headroom among the multiple resource units; determining the target resource based on the ramp profile and the target residency time; or a combination thereof. The method 700 further includes calculating a target residency time for the target task.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a monitoring block configured to calculate a present power for each of multiple resource units;
a thermal block, coupled to the monitoring block, configured to dynamically calculate a thermal candidate set based on the present power, the thermal candidate set for representing a present thermal load for the multiple resource units; and
a target block, coupled to the thermal block, configured to determine a target resource based on the thermal candidate set for performing a target task using the target resource.

2. The system as claimed in claim 1 wherein:
the thermal block is configured to dynamically calculate a thermal headroom corresponding to the multiple resource units; and
the target block is configured to determine the target resource corresponding to greatest instance of the thermal headroom among the multiple resource units.

3. The system as claimed in claim 1 wherein:
the monitoring block is configured to calculate a target residency time for the target task;
the thermal block is configured to dynamically determine a ramp profile corresponding to each of the multiple resource units for describing changes to the present thermal load over time; and
the target block is configured to determine the target resource based on the ramp profile and the target residency time.

4. The system as claimed in claim 1 wherein the thermal block is configured to:
determine a thermal resistance-capacitance network for representing thermal interactions between the multiple resource units; and
dynamically calculate the thermal candidate set based on the present power and the thermal resistance-capacitance network.

5. The system as claimed in claim 1 wherein the thermal block is configured to:
determine a thermal model for representing the present thermal load corresponding to the present power of the multiple resource units; and
dynamically calculate the thermal candidate set based on the thermal model.

6. The system as claimed in claim 1 wherein:
the monitoring block is configured to identify the target task for performing the target task using one of the multiple resource units;
the thermal block is configured to:
identify a throttling threshold corresponding to each of the multiple resource units;
calculate the present thermal load based on the present power of the multiple resource units; and
dynamically calculate the thermal candidate set based on the throttling threshold and the present thermal load.

7. The system as claimed in claim 1 wherein:
the thermal block is configured to dynamically calculate a thermal headroom corresponding to each of the multiple resource units based on a difference between the present thermal load and the throttling threshold of the multiple resource units; and
the target block is configured to determine the target resource corresponding to greatest instance of the thermal headroom among the multiple resource units.

8. The system as claimed in claim 6 wherein:
the monitoring block is configured to calculate a target residency time for performing the target task;
the thermal block is configured to dynamically determine a ramp profile corresponding to each of the multiple resource units based on a thermal resistance-capacitance network and the present power of each of multiple resource units; and
the target block is configured to determine the target resource based on the ramp profile and the target residency time.

9. The system as claimed in claim 6 wherein:
the monitoring block is configured to identify active nodes and resting nodes among the multiple resource units;
the thermal block is configured to:
identify the throttling threshold of the resting nodes;
calculate the present thermal load for the resting nodes based on the present power of the active nodes;
dynamically calculate the thermal candidate set including the resting nodes influenced by the active nodes; and
the target block is configured to determine the target resource from among the resting nodes in the thermal candidate set.

10. The system as claimed in claim 6 wherein:
the thermal block is configured to dynamically calculate thermal candidate set including an available capacity calculated based on a thermal headroom, the present power, and the thermal resistance-capacitance network of the multiple resource units;
the target block is configured to determine the target resource based on the available capacity.

11. A method of operation of a computing system comprising:
calculating a present power for each of multiple resource units;
dynamically calculating with a control unit a thermal candidate set based on the present power, the thermal candidate set for representing a present thermal load for the multiple resource units; and
determining a target resource based on the thermal candidate set for performing a target task using the target resource.

12. The method as claimed in claim 11 wherein:
dynamically calculating the thermal candidate set includes dynamically calculating a thermal headroom corresponding to the multiple resource units; and
determining the target resource includes determining the target resource corresponding to greatest instance of the thermal headroom among the multiple resource units.

13. The method as claimed in claim 11 further comprising:
calculating a target residency time for the target task;
wherein:
dynamically calculating the thermal candidate set includes dynamically determining a ramp profile corresponding to each of the multiple resource units for describing changes to the present thermal load over time; and
determining the target resource includes determining the target resource based on the ramp profile and the target residency time.

14. The method as claimed in claim 11 wherein dynamically calculating the thermal candidate set includes:
determining a thermal resistance-capacitance network for representing thermal interactions between the multiple resource units; and
dynamically calculating the thermal candidate set based on the present power and the thermal resistance-capacitance network.

15. The method as claimed in claim 11 wherein dynamically calculating the thermal candidate set includes:
determining a thermal model for representing the present thermal load corresponding to the present power of the multiple resource units; and
dynamically calculating the thermal candidate set based on the thermal model.

16. A computing system comprising:
a resource identification block configured to identify multiple resource units within a resource portion;
an individual modeling block, coupled to the resource identification block, configured to generate unit-thermal profile for representing each of the multiple resource units;
a relational modeling block, coupled to the individual modeling block, configured to generate a resource set profile including the unit-thermal profile for representing a relationship between the multiple resource units; and
a characterization block, coupled to the relational modeling block, configured to calculate a thermal resistance-capacitance network based on the resource set profile for representing thermal interactions between the multiple resource units.

17. The system as claimed in claim 16 wherein the characterization block is configured to generate a thermal model for the resource portion based on the resource set profile for representing a present thermal load corresponding to a present power of the multiple resource units.

18. The system as claimed in claim 16 wherein:
the resource identification block is configured to locate the multiple resource units within the resource portion;
the relational modeling block is configured to generate the resource set profile including a node-relative location for locating the multiple resource units relative to each other; and
the characterization block is configured to calculate the thermal resistance-capacitance network based on the node-relative location.

19. The system as claimed in claim 16 wherein:
the resource identification block is configured to locate the multiple resource units within the resource portion;
the relational modeling block is configured to generate the resource set profile including a node-relative location for locating the multiple resource units relative to the resource portion; and
the characterization block is configured to calculate the thermal resistance-capacitance network based on the node-relative location.

20. The system as claimed in claim 16 wherein the characterization block is configured to calculate the thermal resistance-capacitance network for determining a target resource for performing a target task based on dynamically calculating a thermal candidate set with the thermal resistance-capacitance network.
